(19) United States
(12) Patent Application Publication
(10) Pub. No.: US 2014/0272888 A1
(43) Pub. Date: Sep. 18, 2014

(54) Engaging a Plurality of Users in an Interactive Activity in an Educational Environment

(71) Applicants: Xeth Waxman, Scottsdale, AZ (US); Paul Clayton Fowler, Scottsdale, AZ (US); Paul Buckley, Chandler, AZ (US); Mike McClaran, Phoenix, AZ (US)

(72) Inventors: Xeth Waxman, Scottsdale, AZ (US); Paul Clayton Fowler, Scottsdale, AZ (US); Paul Buckley, Chandler, AZ (US); Mike McClaran, Phoenix, AZ (US)

(21) Appl. No.: 13/828,662

(22) Filed: Mar. 14, 2013

(51) Int. Cl. G09B 5/02

(52) U.S. Cl. CPC G09B 5/02
USPC 434/350

(57) ABSTRACT

Engaging a plurality of users in an interactive activity in an educational environment includes receiving information that corresponds to an annotation entered by a first user of a first subordinate device of a plurality of subordinate devices. A representation of the annotation entered by the first user while the first user is annotating on the first subordinate device is presented, using a processor, on an instructor device. Information is received that corresponds to an annotation entered by a second user of a second subordinate device of the plurality of subordinate devices. A representation of the annotation entered by the second user is presented on the second the instructor device using the processor while the second user is annotating on the second subordinate device and while the instructor device simultaneously presents the representation of the annotation entered by the first user on the first subordinate device.

### TECHNICAL FIELD

This invention relates generally to engaging in interactive activities, and more specifically to engaging a plurality of users in an interactive activity in an educational environment.

### BACKGROUND

Incorporation of technology into the classroom has been an increasing trend in recent years. Communication systems allow teachers to provide more information to, and receive more feedback from, their students. However, the technological elements are not fully interactive. This incomplete interactivity reduces the overall efficiency of the education process.

### SUMMARY OF EXAMPLE EMBODIMENTS

In accordance with particular embodiments, disadvantages and problems associated with previous techniques for engaging users in interactive activity in an educational environment may be reduced or eliminated.

According to an embodiment, engaging a plurality of users in an interactive activity in an educational environment includes receiving information that corresponds to an annotation entered by a first user of a first subordinate device of a plurality of subordinate devices. A representation of the annotation entered by the first user while the first user is annotating on the first subordinate device is presented, using a processor, on an instructor device. Information is received that corresponds to an annotation entered by a second user of a second subordinate device of the plurality of subordinate devices. A representation of the annotation entered by the second user is presented on the second the instructor device using the processor while the second user is annotating on the second subordinate device and while the instructor device simultaneously presents the representation of the annotation entered by the first user on the first subordinate device.

Certain embodiments may provide one or more technical advantages. A technical advantage of an embodiment includes the ability to engage students using electronic devices in complex, higher-order learning activities using open-ended questions, such as short answer questions, as well as closed questions, such as a multiple choice questions. Additionally, a technical advantage of an embodiment includes the ability for an instructor to view the activity of multiple student devices participating in the activity. The activity may be presented on an instructor device in real-time, allowing the instructor flexibility to determine when to engage in learning intervention. Another technical advantage of an embodiment includes the ability to share the work of multiple students on a common display simultaneously viewable by all students engaging in the interactive activity.

Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of particular embodiments and for further features and advantages thereof, reference is now made to the following description taken in conjunction with the accompanying drawings, in which:

FIG. 1 illustrates an example system for engaging a plurality of users in an interactive activity.

FIG. 2 illustrates an example instructor device that facilitates selection of an interactive activity to engage users of subordinate devices.

FIG. 3 illustrates an example system comprising subordinate devices engaging in an interactive activity and communicating with an instructor device.

FIG. 4 is a flowchart illustrating an example method for engaging a plurality of users in an interactive activity.

### DETAILED DESCRIPTION OF EXAMPLE EMBODIMENTS

FIG. 1 illustrates an example system 10 for engaging a plurality of users in an interactive activity. System 10 includes an instructor device 104 that communicates with computer 106 and subordinate devices 110 over network 102. In particular embodiments, instructor device 104 causes content to be displayed on devices 110. The users of devices 110 interact with and annotate the content displayed on devices 110. The particular annotations entered on all or a portion of devices 110 may be displayed on instructor device 104 simultaneously while the users of devices 110 annotate their respective displays. Instructor device 104 causes any suitable number of annotations entered on devices 110 to be shown in any suitable order on common display 108, which may be simultaneously viewable to the users of devices 110.

Selectively displaying the annotations of multiple users of devices 110 enables an instructor to effectively allow multiple users to “show their work” in an education environment. An “education environment” may be a traditional classroom environment, a meeting, a focus group, or any other gathering in which an instructor or moderator interacts with a group using display 108. System 10 may be useful in environments where it is desirable to view selections of particular predefined responses (e.g., multiple choice, true/false, yes/no, etc.) as well as freeform or otherwise constructed responses or annotations (e.g., short answer, math problem analysis, diagram labeling, etc.) entered by users of subordinate devices 110.

The components of system 10 communicate using network 102. Network 102 represents any suitable network that facilitates communication between the components of system 10. Network 102 may include any interconnecting system capable of transmitting audio, video, signals, data, messages, or any combination of the preceding. Network 102 may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, any other suitable communication link, including combinations thereof operable to facilitate communication between the components of system 10.

In certain embodiments, network 102 represents a wireless network accessible to components of system 10 and inaccessible to the general public. For example, network 102 may be a wireless network principally located at a school or in a classroom of a school. Additionally, instructor device 104 and devices 110 may communicate directly over network 102 or may communicate indirectly through computer 106 as will be described in more detail below.

Instructor device 104 represents any suitable interactive device operable to control display 108 and/or the modes of operation of devices 110. Non-limiting examples of instructor device 104 include a tablet, mobile phone, personal digital assistant, laptop, netbook, ultrabook, desktop computer, and/or any other suitable device. Lightweight embodiments of instructor device 104 comprising a wireless network interface, such as a tablet computer embodiment, may allow an instructor or other user of instructor device 104 to move unencumbered in a classroom or other setting among the users of devices 110. In particular embodiments, instructor device 104 includes a network interface 112, memory 114, processor 118, and graphical user interface 120.

Graphical user interface 120 displays information and available functionality to an instructor or other user of instructor device 104. Graphical user interface 120 allows an instructor to select an interactive activity to be performed by users of devices 110. The instructor may also select specific content to be displayed on devices 110 while the users of devices 110 engage in the interactive activity. Instructor device 104 causes the content to be delivered to devices 110 by sending it directly, by causing computer 106 to deliver the content to devices 110, and/or any other suitable manner.

While the users of devices 110 engage in the interactive activity and enter annotations on the displayed content, the respective annotations of each user may appear in a film strip 122 on graphical user interface 120 as thumbnails 124 or in any other suitable manner. The images of thumbnails 124 may change in real-time as the users enter content on devices 110. One of ordinary skill in the art will recognize that “real-time” operations may accommodate certain time-lapses or delays inherent in using communication devices, such as instructor device 104 and subordinate devices 110.

Film strip 122 may appear in any suitable format. For example, film strip 122 may have an adjustable size depending on the number of subordinate users engaging in the interactive activity with one or more rows of thumbnails 124, such that all annotations of devices 110 are simultaneously viewable in film strip 122. The size of each thumbnail 124 may change (e.g., get smaller) to accommodate displaying thumbnails 124 that correspond to annotations entered at a large number of devices 110.

In certain embodiments, film strip 122 may include any suitable control features such as arrow 126. An instructor may select arrow 126 to reveal additional thumbnails 124 of annotations entered on devices 110 not currently shown on instructor device 104. In certain embodiments, instructor device 104 may be configured to allow the instructor to use a finger swipe, a mouse, and/or any other suitable input feature to reveal additional thumbnails 124 not currently shown on instructor device 104.

Graphical user interface 120 may also include content sharing control 128. Content sharing control 128 facilitates display of annotations entered by subordinate users of devices 110 onto common display 108. For example, an instructor using instructor device 104 may drag and drop one or more thumbnails 124 onto content sharing control 128, which causes the annotations to be displayed on common display 108. Graphical user interface 120 allows the instructor to order the selected thumbnails 124 in any suitable order/layout on content sharing control 128, which may be reconfigured by the instructor at any time. The order/layout chosen for content sharing control 128 may be mirrored on common display 108. The annotations entered onto devices 110 may be shown on common display 108 as they are being entered by the users of devices 110 (i.e., in real-time).

In certain embodiments, content sharing control 128 may show fewer annotations than shown on common display 108. This may be helpful in such cases where the number of annotations to be shown exceeds the amount comfortably viewable on content sharing control 128 of instructor device 104 at once. In such embodiments, the instructor may still drag and drop any suitable number of thumbnails 124 onto content sharing control 128 to cause them to be displayed on display 108.

Where appropriate, instructor device 104 may be configured to automatically cause the annotations of all devices 110 in system 10 to be presented on common display 108. In particular embodiments, once the particular devices 110 have been selected for presentation on common display 108, instructor device 104 may choose a suitable display configuration of the annotations entered by users of selected devices 110. The configuration chosen for presentation on common display 108 may be chosen based on number of annotations selected, content of the annotations, and/or any other suitable factor. For example, instructor device 104 may choose automatically to lay out the annotations in any suitable number of rows when the number chosen for display exceeds a specified threshold.

As another example, instructor device 104 may cause the annotations to be displayed in rotating fashion (e.g., when the annotations are fairly detailed). In this example, one, two, or any other suitable number of annotations may be displayed on common display 128 for a specified amount of time before being removed and replaced with another set of annotations from other devices 110 continuing through the remaining annotations to be displayed and repeating again with the first set of annotations. While the particular annotations are displayed, they will continue to be updated in real-time as the users of devices 110 modify the annotations. In particular embodiments, instructor device 104 may be configured to cycle through the displays of devices 110 being actively annotated while passing over the displays of devices 110 that have remained stagnant for an amount of time that exceeds a certain threshold. In certain embodiments, instructor device 104 may pause the rotation for any suitable amount of time, such that the particular annotations shown on display 108 remain the same. This may allow an instructor using device 104 to provide feedback and/or other instruction to all users of devices 110.

Network interface 112 represents any suitable device operable to receive information from network 102, perform suitable processing of the information, communicate to other devices, or any suitable combination of the preceding. For example, network interface 112 may be used to provide an instruction for particular content to be delivered to devices 110 for new annotations. Where appropriate, this content may be communicated directly to devices 110 and/or through computer 106. Network interface 112 represents any port or connection, real or virtual, including any suitable hardware and/or software, including protocol conversion and data processing capabilities, to communicate through a LAN, WAN, or other communication systems that allows instructor device 104 to exchange information with the other components of system 10.

Memory 114 stores, either permanently or temporarily, data, operational software, or other information for processor 118. Memory 114 includes any one or a combination of volatile or nonvolatile local or remote devices suitable for storing information. For example, memory 114 may include random access memory (RAM), read only memory (ROM), magnetic storage devices, optical storage devices, or any other suitable information storage device or a combination of these devices. While illustrated as including particular modules, memory 114 may include any suitable information for use in the operation of instructor device 104.

In certain embodiments, memory 114 includes logic 116. Logic 116 represents any suitable set of instructions, logic, or code embodied in a non-transitory, computer readable medium and operable to facilitate the operation of instructor device 104. For example, logic 116 may include operating system code, application files, and/or rules for indicating the appropriate content to display on graphical user interface 120 under various circumstances, such as while annotations are being entered on devices 110. The application files may comprise software specifically customized for use on instructor device 104 that has some control over subordinate devices 110.

Logic 116 may reference information stored in data 117. Data 117 may include, for example, content that the instructor causes to be communicated to be displayed on devices 110 for annotation. The content for annotation may include, for example, math problems, a structure that needs labeling, and/or any other suitable example.

Processor 118 communicatively couples to network interface 112 and memory 114. Processor 118 controls the operation and administration of instructor device 104 by processing information received from network interface 112 and memory 114. Processor 118 includes any hardware and/or software that operates to control and process information. For example, processor 118 executes logic 116 to control the operation of instructor device 104. Processor 118 may be a programmable logic device, a microcontroller, a microprocessor, any suitable processing device, or any suitable combination of the preceding.

Computer 106 represents any suitable device that communicates with instructor device 104, subordinate devices 110, and display 108. In certain embodiments, computer 106 drives the operation of system 10 and the components within system 10, such as instructor device 104, display 108, and subordinate devices 110. To facilitate the communication and display of information, computer 106 executes applications, such as a word processing application, a presentation application, a training program, a web browser, an educational application, a web-based application, or any other suitable application. In certain embodiments, computer 106 includes a wireless interface 130, processor 132, network interface 134, and memory 136. Computer 106 comprises any suitable type of device that manipulates data according to instructions, such as a personal computer, a laptop, a desktop, or any other suitable type of computer.

Wireless interface 130 represents any suitable element that communicates wireless signals. For example, wireless interface 130 may include an antenna, sensor, emitter, receiver, transmitter, or other suitable component to communicate a wireless signal. Wireless interface 130 represents any port or connection, real or virtual, including any suitable hardware and/or software that allows instructor device 104 to communicate wireless signals. Wireless signals may include any suitable wireless signal, such as a radio frequency signal (e.g., 802.11 or WiFi signal), an infrared signal, or any other suitable wireless signal.

Processor 132 processes information to exchange with instructor device 104 and subordinate devices 110 and transmits information to display 108. Processor 132 may also manage components in system 10. For example, processor 132 runs an application that manages the information communicated to display 108. Processor 132 includes any hardware, software, or both that operate to control and process information in system 10. For example, processor 132 may be a programmable logic device, a microcontroller, a microprocessor, any suitable processing device, or any combination of the preceding. In a particular embodiment, processor 132 is the central processing unit of a personal computer. In another embodiment, processor 132 is distributed among components of system 10.

Network interface 134 represents any suitable element that communicates information between computer 106 and a public or private network. Network interface 134 may include any port or connection, real or virtual, wireline or wireless, including any suitable hardware, software, or a combination of the preceding.

Memory 136 stores, either permanently or temporarily, data, logic 138, or other information for processing by processor 132. Memory 136 includes any one or a combination of volatile or nonvolatile local or remote devices suitable for storing information. For example, memory 136 may include magnetic media, optical media, CD-ROMs, DVD-ROMs, removable media, any other suitable information storage device, or any suitable combination of these devices. Memory 136 stores logic 138.

Logic 138 represents a set of instructions that processor 132 executes to control the operation of computer 106. Logic 138 includes operating system code, applications, user files, logic modules, or any other executable software or data files.

Display 108 represents any suitable component that displays information to the user of instructor device 104 and to users of subordinate devices 110. Display 108 may include a monitor, a projection screen, a television screen, or any other suitable device that visually displays information. Display 108 may be a single display simultaneously visible to the user of instructor device 104 and users of subordinate devices 110. Certain embodiments of display 108 comprise a projector 140 and an adjustable screen 142. Projector 140 may receive information from computer 106 and perform any required translation for projection of an image onto adjustable screen 142.

Display 108 may display annotations entered by one or more users of subordinate devices 110 in the configuration chosen by instructor device 104. The size of screen 142 may be increased or reduced in any suitable manner to accommodate displaying any suitable number of annotations selected for display by instructor device 104. For example, screen 142 may display the annotations entered by users of all or some subset of devices 110 of system 10. In particular embodiments, adjustable screen 142 may be a wall in the classroom. In such embodiments, the size of adjustable screen 142 may be adjusted by configuring the controls of projector 140, moving projector 140 closer or further away from the wall, any other suitable manner of adjustment, and/or any suitable combination of the preceding.

Subordinate devices 110 represent any suitable device for sending information to computer 106 and/or instructor device 104 over network 102. Where appropriate, subordinate devices 110 may receive information, be controlled by instructor device 104, supersede instructions provided by instructor device 104, be controlled directly by a user of device 110, and enter various modes of operation such as annotation mode and/or lock mode. Subordinate devices 110 may include any suitable device, such as any of the devices listed as possibilities for instructor device 104 above. Subordinate devices 110 receive content to display and instructions to enter an annotation mode to allow users of devices 110 to annotate the content displayed. One user may use each device 110 or multiple users may share a particular device 110.

While in annotation mode, certain annotation tools may become available to users of devices 110, such as a pen tool for “writing” on top of displayed content, an eraser tool for removing all or a portion of the entered annotation, a color selection tool for selecting the color of annotations entered on top of displayed content, and/or any other suitable annotation tools. Subordinate devices 110 communicate to instructor device 104 and/or computer 106 information representative of the respective annotations as the respective annotations are being entered by user of devices 110.

Certain embodiments of subordinate devices 110 include a network interface, memory, and processor similar in form and function to network interface 112, memory 114, and processor 118, respectively, of instructor device 104. Application files and rules for displaying/editing content may be customized specifically for subordinate devices 110. For example, subordinate devices 110 may be configured to allow instructor device 104 to have general control over whether devices 110 are in annotation mode, which allows subordinate users to annotate displays of devices 110 using annotation tools. As another example, application files on subordinate devices 110 may be configured to allow instructor device 104 to cause devices 110 to enter a lock mode, which prohibits users of devices 110 from providing further modifications to the annotations entered. Subordinate devices 110 may communicate using any suitable type of signal, such as a wireless radio frequency signal or a wireless infrared signal.

In an example embodiment operation of system 10, a user of instructor device 104 selects an activity to interactively engage the students in a classroom who use devices 110. The instructor chooses a math problem activity for the users of devices 110 to solve. The instructor may state the math problem orally and cause a blank screen to appear on devices 110. In certain embodiments, instructor device 104 may cause devices 110 to display an image that includes a specified math problem. The instructions for devices 110 to display certain content and allow users of devices 110 to annotate the content may be delivered directly to devices 110 and/or via computer 106. In the illustrated embodiment, User1 has entered the number “343” on the display of device 110a and User2 has entered the number “462” on the display of device 110b. The users of other devices 110 may also provide annotations on the displays of particular devices 110.

As the users provide annotations on their respective devices 110, the annotations appear as thumbnails 124 on film strip 122. For example, each digit of the number “343” will appear in real-time on thumbnail 124a, in other words, as User1 enters the annotation on device 110a. Likewise, the annotations entered by the users of the other devices 110 will appear as thumbnails in film strip 122, with the annotations appearing in real-time.

The instructor has chosen annotations of eight devices 110 to appear on common display 108 by dragging them from film strip 122 and dropping them onto content sharing control 128. The instructor may choose any suitable display order for the annotations and/or instructor device 104 may choose a display configuration automatically. The annotations from selected devices 110 are displayed on common display 108 as they are being entered on devices 110. For example, each digit of the number “462” will appear in real-time on common display 108, as User2 enters the annotation on device 110b.

Instructor device 104 may cause the appropriate annotations to appear on common display 108 by communicating the annotations to computer 106 for display on common display 108, instructing computer 106 to present the appropriate annotations on common display 108 as received from devices 110, and/or in any other suitable manner.

Modifications, additions, or omissions may be made to system 10. For example, system 10 may include any suitable number of subordinate devices 110. As another example, computer 106 may include a display in addition to common display 108. As yet another example, system 10 may include more than one instructor device 104. Where appropriate, instructor device 104 may be programmed to choose and/or allow an instructor to selectively choose different content to be displayed on specific devices 110 for annotation. For example, device 110a may display an image of a math problem to be solved while, at the same time, device 110b displays a diagram to be identified and labeled by the user of device 110b.

Moreover, the operations of system 10 may be performed by more, fewer, or other components. Any suitable logic comprising software, hardware, other logic, or any suitable combination of the preceding may perform the functions of system 10. For example, the functions of computer 106 may be performed by instructor device 104 in certain embodiments.

FIG. 2 illustrates an example instructor device 202 that facilitates selection of an interactive activity to engage users of subordinate devices. Instructor device 202 may be used as an instructor device 104 in system 10 of FIG. 1 and/or any other suitable system. The interactive activity may be annotation on top of a background image, creation of an objection, manipulation of an object, completion of a form, taking an assessment, and/or any other suitable interactive activity.

Certain embodiments of instructor device 204 include a graphical user interface that presents an interactive sharing mode selector 204 that, when selected by an instructor or other user of instructor device 202, presents background image controls 206 on a display of instructor device 204.

Selection of a particular background image control 206 facilitates delivery of content to be displayed on one or more subordinate devices 110. For example, selection of background image control 206a causes an image stored on a desktop computer, such as computer 106 in certain embodiments, to be delivered to one or more subordinate devices 110. Selection of background image control 206b causes one or more images taken from a camera to be delivered to one or more subordinate devices 110. Selection of background image control 106c causes a live image being recorded from a camera coupled to instructor device 202, computer 106, any other component of system 10, and/or network 102 (via wireline or wireless connection) to be delivered to one or more subordinate devices 110. Selection of background image control 206d causes a blank screen to be delivered to subordinate devices 110. Selection of background image control 206e causes an image of an x-y coordinate plane to be delivered to subordinate devices 110. Selection of background image control 206f causes an image of a graph to be delivered to subordinate devices 110. Selection of background image control 206g causes an image of a venn diagram to be delivered to subordinate devices 110. Selection of background image control 206h causes an image of lined paper to be delivered to subordinate devices 110. Selection of background image control 206i causes an image of lines formatted to facilitate handwriting practice to be delivered to subordinate devices 110.

Instructor device 104 may deliver suitable content associated with a particular background image control 202 in any suitable manner. For example, instructor device may transmit content directly to subordinate devices 110, cause a separate device such as computer 106 to deliver the content, instruct a subordinate device 110 to retrieve suitable content from its own local storage for display, instruct a subordinate device 110 to display an image retrieved from a network device and/or a locally coupled peripheral device, in any other suitable manner, and/or any suitable combination of the preceding.

Selection of particular background images may comprise receiving input from an instructor or other user of instructor device 202 through a graphical user interface, automatic selection of a background image by instructor device 202 upon entering a predefined class or curriculum, in any other suitable manner, and/or any other suitable combination of the preceding.

Manipulation controls 208 may allow an instructor or other user of instructor device 208 to manipulate the graphical user interface presented on instructor device 208. For example, using manipulation controls 208 may cause the display on instructor device 202 to scroll up, down, left, or right to reveal additional or different background image controls 206. In particular embodiments, the instructor or other user of instructor device 202 may use a finger swipe and/or other selection motions to manipulate a graphical user interface presented on instructor device 202.

Modifications, additions, or omissions may be made to instructor device 202. For example, instructor device 202 may include any suitable number of manipulation controls 208 to facilitate interaction between the instructor/user and instructor device 202. As another example, instructor device 202 may include different background image controls 206, such as a background image control that presents objects such as squares, circles, and/or any other suitable object that, when presented on subordinate devices 110, may be manipulated in any suitable manner. Additionally, any suitable logic comprising software, hardware, other logic, or any suitable combination of the preceding may perform the functions of instructor device 202.

FIG. 3 illustrates a system 302 comprising subordinate devices 304 communicating with instructor device 308. Subordinate devices 304 may be used as subordinate devices 110 and instructor device 308 may be used as an instructor device 104 in system 10 of FIG. 1 and/or any other suitable system. Instructor device 308 presents annotations entered on subordinate devices 304 in real-time.

As an example, instructor device 308 selects an image annotation activity and delivers an image of a math problem to subordinate devices 304. The math problem is titled “Example #1” and is “14÷7·2−3.” At the same time that the content of the math problem is delivered to devices 304, instructor device 308 causes devices 304 to enter an annotation mode, such that the image of the math problem may be annotated by users of devices 304. While in annotation mode, certain embodiments of devices 304 will enable user annotations tools, such as user annotation tools 306. User annotation tools 306 include a pen tool, eraser tool, color selection tool, a width selection tool, and any other suitable annotation tools.

As the users of devices 304 begin to annotate the math problem, the annotations appear on instructor device 308. Film strip 310 presents each of the annotations entered on devices 304 represented by thumbnails 312. For example, thumbnail 312 shows that the user of device 304a initially entered “2·−1” to attempt to solve the math problem. The user of device 304a may have realized that this violated the correct order of operations for mathematics equations and crossed that line out. The user of device 304a then entered “2·2−3,” utilizing the correct order of operations. Each step of the user's annotation is viewable as thumbnail 312a on instructor device 308 as it is entered on device 304a. As another example, instructor device 308 presents the real-time annotation of device 304c as thumbnail 312c on film strip 310. The user of device 304c appears to be distracted as indicated by the drawing of a smiley face instead of mathematical analysis to solve the math problem presented. Because the annotation entered on device 304c is presented on instructor device 308 in real-time, the instructor or other user of instructor device 308 may be alerted to this conduct immediately and, thus, may engage the user of device 304c directly to rectify the situation.

Likewise, the user of device 304d has not made much progress in solving the math problem, which may indicate that the user needs assistance. The progress of the annotation of device 304d is also presented as a thumbnail on film strip 310 (not shown). As with the distracted user of device 304c, the instructor or other user of instructor device 308 may engage the user of device 304d directly to determine the reason for the lack of progress and initiate a solution. Thumbnails 312 not currently shown, such as thumbnail 312d corresponding to the annotation entered on device 304d, may be revealed by using a finger swipe on film strip 310, using a arrow selector controlled by a computer mouse to manipulate the film strip, using instructor controls 314 to manipulate the display of instructor device 308, and/or by any other suitable manner. Film strip 310 may comprise any suitable number of thumbnails 312 to facilitate presentation of the annotations of devices 304 presented in system 302. In certain embodiments, film strip 310 may include a maximum number of 100 thumbnails 312.

The instructor or other user of instructor device 308 may cause the annotations of one or more devices 304 to appear on a common display simultaneously viewable by users of multiple devices 304, such as common display 108 of system 10 of FIG. 1. In certain embodiments, this may be accomplished by dragging any suitable number of thumbnails 312 onto content sharing control 316. Instructor device 308 may order the annotations in any suitable manner on content sharing control 316 in any suitable layout. In particular embodiments, content sharing control 316 includes the annotations entered by User1 and User2. The real-time annotations of these users will be presented on a common display.

Lock mode control 318 may be selected to cause devices 304 to lock the annotations of devices 304. While in lock mode, users of devices 304 will not be able to modify the annotations already entered on devices 304 and will not be able to provide additional annotations. In certain embodiments, instructing devices 304 to enter lock mode will cause devices 304 to temporarily display a “lock” symbol or other indicator to alert the users of devices 304 that annotation operation is currently prohibited. Lock mode control 318 may be selected again to cause devices 304 to re-enter annotation mode.

Selection of stop control 320 may end the current interactive activity. In certain embodiments, upon stopping the activity, the annotations of devices 304 may be saved on subordinate devices 304, instructor device 308, a control computer such as computer 106 of system 10, any other suitable storage mechanism, and/or any other suitable combination of the preceding.

Modifications, additions, or omissions may be made to system 302. For example, instructor device 308 may present any suitable number of thumbnails 312 simultaneously in film strip 310. As another example, content sharing control 316 may include any suitable number of thumbnails 312, thus causing any suitable number of annotations to be presented on a common display.

FIG. 4 is a flowchart illustrating an example method 400 for engaging a plurality of users in an interactive activity. At step 402, an interactive activity is selected on instructor device, such as instructor device 104. The selection may occur as a result of receiving input from an instructor or other user of the instructor device.

At step 404, the selected activity and/or the content corresponding to that activity are delivered to subordinate devices, such as subordinate devices 110. The subordinate devices enter an annotation mode at step 406. The content may be displayed on the subordinate device and certain annotation tools may be enabled to facilitate annotation of the content. At step 408, the instructor device begins to receive information corresponding to the annotations entered on the subordinate devices. The annotations are presented in a film strip on the instructor device at step 410. At step 412, the instructor device causes any suitable number of the annotations of the subordinate devices to be displayed on a separate display. At step 414, the method determines whether a lock control has been selected on the instructor device. If the lock control has been selected, the subordinate devices are instructed to enter a lock mode that prohibits further annotations by users of the subordinate devices. When the lock mode has been disabled, the method proceeds to step 418. At step 418, the method determines whether the instructor device will continue to receive real-time annotations. If so, the method returns to step 408. If not, the annotations of the users of the subordinate devices may be saved, and the method ends.

Modifications, additions, and omissions may be made to method 400 disclosed herein without departing from the scope of the particular embodiments. The methods may include more, fewer, or other steps. For example, an additional step may be included that selects and/or modifies the configuration of the presented annotations on the common display. Although described in a particular sequence, the steps in the flowchart may occur serially or in parallel in any suitable order. For example, steps 404 and 406 may occur in parallel such that content is delivered and the subordinate devices enter annotation mode at the same time.

A component of the systems and apparatuses disclosed herein may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

Although particular embodiments have been described, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for engaging a plurality of users in an interactive activity in an educational environment, comprising:
receiving information that corresponds to an annotation entered by a first user of a first subordinate device of a plurality of subordinate devices;
presenting, using a processor, on an instructor device a representation of the annotation entered by the first user while the first user is annotating on the first subordinate device;
receiving information that corresponds to an annotation entered by a second user of a second subordinate device of the plurality of subordinate devices; and
presenting, using the processor, on the instructor device a representation of the annotation entered by the second user while the second user is annotating on the second subordinate device and while the instructor device simultaneously presents the representation of the annotation entered by the first user on the first subordinate device.

2. The method of claim 1, further comprising:
selecting an activity that corresponds to content to be presented on the plurality of subordinate devices; and
delivering the content to the plurality of subordinate devices; and
causing the plurality of subordinate devices to enter an annotation mode, wherein the annotation of the first user is overlaid onto the content presented on the first subordinate device and the annotation of the second user is overlaid onto the content presented on the second subordinate device.

3. The method of claim 1, further comprising selecting an activity that corresponds to content to be presented on the plurality of subordinate devices, wherein the activity is selected from a group comprising annotation on top of an image, creation of an object, manipulation of an object, completion of a form, and taking an assessment.

4. The method of claim 1, further comprising presenting, on the instructor device, the representation of the annotation entered by the first user and the representation of the annotation entered by the second user as thumbnail images of a film strip, wherein the thumbnail images are updated in real-time.

5. The method of claim 1, further comprising facilitating presentation of both the representation of the annotation entered by the first user and the representation of the annotation entered by the second user on a common display simultaneously viewable by the users of at least two of the plurality of subordinate devices.

6. The method of claim 1, further comprising facilitating presentation of both the representation of the annotation entered by the first user and the representation of the annotation entered by the second user on a common display, wherein the common display has an adjustable size.

7. The method of claim 1, further comprising providing an instruction operable to prevent the user of the first subordinate device from providing further annotation.

8. An instructor device for engaging a plurality of users in an interactive activity in an educational environment, comprising:
a memory comprising rules for engaging users of a plurality of subordinate devices in an interactive activity in an educational environment;
a graphical user interface for presenting annotations entered on the plurality of subordinate devices; and
a processor communicatively coupled to the memory and operable to:
receive information that corresponds to an annotation entered by a first user of a first subordinate device of the plurality of subordinate devices;
present on the graphical user interface a representation of the annotation entered by the first user while the first user is annotating on the first subordinate device;
receive information that corresponds to an annotation entered by a second user of a second subordinate device of the plurality of subordinate devices; and
present on the graphical user interface a representation of the annotation entered by the second user while the second user is annotating on the second subordinate device and while the graphical user interface simultaneously presents the representation of the annotation entered by the first user on the first subordinate device.

9. The device of claim 8, the processor further operable to:
select an activity that corresponds to content to be presented on the plurality of subordinate devices; and
deliver the content to the plurality of subordinate devices; and
cause the plurality of subordinate devices to enter an annotation mode, wherein the annotation of the first user is overlaid onto the content presented on the first subordinate device and the annotation of the second user is overlaid onto the content presented on the second subordinate device.

10. The device of claim 8, the processor further operable to select an activity that corresponds to content to be presented on the plurality of subordinate devices, wherein the activity is selected from a group comprising annotation on top of an image, creation of an object, manipulation of an object, completion of a form, and taking an assessment.

11. The device of claim 8, the processor further operable to present, on the graphical user interface, the representation of the annotation entered by the first user and the representation of the annotation entered by the second user as thumbnail images of a film strip, wherein the thumbnail images are updated in real-time.

12. The device of claim 8, the processor further operable to facilitate presentation of both the representation of the annotation entered by the first user and the representation of the annotation entered by the second user on a common display simultaneously viewable by the users of at least two of the plurality of subordinate devices.

13. The device of claim 8, the processor further operable to facilitate presentation of both the representation of the annotation entered by the first user and the representation of the annotation entered by the second user on a common display, wherein the common display has an adjustable size.

14. A non-transitory computer readable medium comprising logic, the logic when executed by a processor, operable to:
receive information that corresponds to an annotation entered by a first user of a first subordinate device of a plurality of subordinate devices;
present, using a processor, on an instructor device a representation of the annotation entered by the first user while the first user is annotating on the first subordinate device;
receive information that corresponds to an annotation entered by a second user of a second subordinate device of the plurality of subordinate devices; and
present, using the processor, on the instructor device a representation of the annotation entered by the second user while the second user is annotating on the second subordinate device and while the instructor device simultaneously presents the representation of the annotation entered by the first user on the first subordinate device.

15. The computer readable medium of claim 14, wherein the logic is further operable to:
select an activity that corresponds to content to be presented on the plurality of subordinate devices; and
deliver the content to the plurality of subordinate devices; and
cause the plurality of subordinate devices to enter an annotation mode, wherein the annotation of the first user is overlaid onto the content presented on the first subordinate device and the annotation of the second user is overlaid onto the content presented on the second subordinate device.

16. The computer readable medium of claim 14, wherein the logic is further operable to select an activity that corresponds to content to be presented on the plurality of subordinate devices, wherein the activity is selected from a group comprising annotation on top of an image, creation of an object, manipulation of an object, completion of a form, and taking an assessment.

17. The computer readable medium of claim 14, wherein the logic is further operable to present, on the instructor device, the representation of the annotation entered by the first user and the representation of the annotation entered by the second user as thumbnail images of a film strip, wherein the thumbnail images are updated in real-time.

18. The computer readable medium of claim 14, wherein the logic is further operable to facilitate presentation of both the representation of the annotation entered by the first user and the representation of the annotation entered by the second user on a common display simultaneously viewable by the users of at least two of the plurality of subordinate devices.

19. The computer readable medium of claim 14, wherein the logic is further operable to facilitate presentation of both the representation of the annotation entered by the first user and the representation of the annotation entered by the second user on a common display, wherein the common display has an adjustable size.

20. The computer readable medium of claim 14, wherein the logic is further operable to provide an instruction operable to prevent the user of the first subordinate device from providing further annotation.
